(19) United States
(12) Patent Application Publication
(10) Pub. No.: US 2025/0224739 A1
(43) Pub. Date: Jul. 10, 2025

(54) SPEED CONTROL FOR AUTONOMOUS VEHICLE IN HIGH PERFORMANCE DRIVING BEHAVIOR REGION

(71) Applicant: Caterpillar Inc., Peoria, IL (US)

(72) Inventors: Sagar CHOWDHURY, Antioch, CA (US); Karl KIRSCH, Chillicothe, IL (US); Matthew D. JOHNSON, Dunlap, IL (US); Matthew Alan HOLMES, Metamora, IL (US)

(73) Assignee: Caterpillar Inc., Peoria, IL (US)

(21) Appl. No.: 18/407,922

(22) Filed: Jan. 9, 2024

(51) Int. Cl. G05D 1/65; G05D 1/24; G05D 1/622; G05D 1/693; G05D 107/70; G05D 109/10

(52) U.S. Cl. CPC G05D 1/65; G05D 1/24; G05D 1/622; G05D 1/693; G05D 2107/73; G05D 2109/10

(57) ABSTRACT

The controller of the present disclosure enables an autonomous vehicle to travel at increased speed in a high performance driving behavior region (HPDBR), such as when a likelihood of the autonomous vehicle driving off course or colliding with other vehicles and/or people at the work site is low. In some implementations, a controller of an autonomous vehicle may obtain autonomous vehicle position information. The controller may determine, based on the autonomous vehicle position information, that the autonomous vehicle is located within an HPDBR of an autonomous driving area. The controller may determine, based on determining that the autonomous vehicle is located within the HPDBR, whether an HPDBR-related risk exists. The controller may cause, based on determining whether an HPDBR-related risk exists, an autonomous vehicle speed control operation to be performed.

### TECHNICAL FIELD

The present disclosure relates generally to speed control for an autonomous vehicle and, for example, to speed control for an autonomous vehicle in a high performance driving behavior region.

### BACKGROUND

Speed control of an autonomous vehicle (e.g., an autonomous mining truck, or another type of autonomous vehicle) may involve causing a speed of the autonomous vehicle to be set at a particular level in a first section of an autonomous driving area (e.g., due to one or more physical characteristics of the first region, such as wide lane width) and to be decreased in a second section of the autonomous driving area (e.g., due to one or more physical characteristics of the second region, such as a narrow lane width). In this way, by traveling at a decreased speed in the second section, the autonomous vehicle may be controlled in a manner that promotes safety at a work site (e.g., by minimizing a likelihood of the autonomous vehicle driving off course or colliding with other vehicles and/or people at the work site), but that impacts a productivity of the autonomous vehicle (e.g., because lower speeds increase travel time of the autonomous vehicle).

U.S. Pat. No. 11,237,562 (the '562 patent) discloses avoiding potential collisions between autonomous and manned vehicles and avoiding contact between autonomous and manned vehicles caused by loss of traction. In contrast, the controller of the present disclosure enables an autonomous vehicle to travel at increased speed in a high performance driving behavior region (HPDBR), further described herein, when a likelihood of the autonomous vehicle driving off course or colliding with other vehicles and/or people at the work site is low.

The controller of the present disclosure solves one or more of the problems set forth above and/or other problems in the art.

### SUMMARY

In some implementations, an autonomous vehicle comprising: a positioning system; and a controller configured to: obtain autonomous vehicle position information (e.g., position information of the autonomous vehicle) from the positioning system; determine, based on the autonomous vehicle position information, that the autonomous vehicle is located within a high performance driving behavior region (HPDBR) of an autonomous driving area; determine, based on a speed limit range of the HPDBR and the autonomous vehicle position information, one or more potential paths of the autonomous vehicle; determine, based on the one or more potential paths of the autonomous vehicle, whether an autonomous vehicle lane breach risk exists; and cause, based on determining whether an autonomous vehicle lane breach risk exists, an autonomous vehicle speed control operation to be performed.

In some implementations, a controller of an autonomous vehicle includes one or more memories; and one or more processors configured to: obtain autonomous vehicle position information from a positioning system of the autonomous vehicle; determine, based on the autonomous vehicle position information, that the autonomous vehicle is located within an HPDBR of an autonomous driving area; obtain, based on determining that the autonomous vehicle is located within the HPDBR, other vehicle position information (e.g., position information of another vehicle); determine, based on the other vehicle position information, one or more estimated trajectories of another vehicle; determine, based on the one or more estimated trajectories of the other vehicle, whether an HPDBR intersection risk exists; and cause, based on determining whether an HPDBR intersection risk exists, an autonomous vehicle speed control operation to be performed.

In some implementations, a method includes obtaining, by a controller of an autonomous vehicle, autonomous vehicle position information; determining, by the controller and based on the autonomous vehicle position information, that the autonomous vehicle is located within an HPDBR of an autonomous driving area; determining, by the controller and based on determining that the autonomous vehicle is located within the HPDBR, whether an HPDBR-related risk exists; and causing, by the controller and based on determining whether an HPDBR-related risk exists, an autonomous vehicle speed control operation to be performed.

### BRIEF DESCRIPTION OF THE DRAWINGS

FIG. 1 is a diagram of an example implementation described herein.

FIGS. 2A-2B are diagrams associated with an example physical region described herein.

FIGS. 3A-3D are diagrams associated with an example implementation.

FIG. 4 is a diagram of example components of a device associated with speed control for an autonomous vehicle in an HPDBR.

FIG. 5 is a flowchart of an example process associated with speed control for an autonomous vehicle in an HPDBR.

### DETAILED DESCRIPTION

This disclosure relates to controller of an autonomous vehicle, which is applicable to any autonomous vehicle that uses a controller for speed control. The autonomous vehicle may be any type of autonomous vehicle configured to perform operations associated with an industry such as mining, construction, farming, transportation, or any other industry.

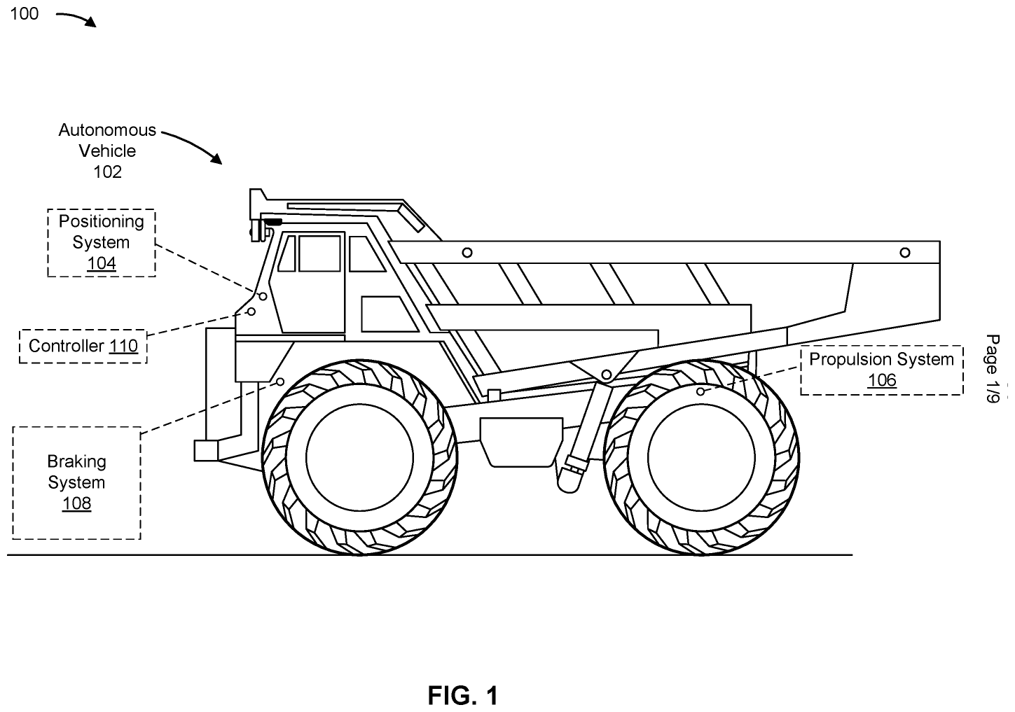

FIG. 1 is a diagram of an example implementation 100 described herein. As shown in FIG. 1, the implementation 100 may include an autonomous vehicle 102. The autonomous vehicle 102 may be, for example, an off-highway truck (e.g., a mining truck, such as autonomous mining truck (AMT)), a mining shovel, a wheel loader, a track loader, a backhoe, a hydraulic excavator, or any other type of autonomous vehicle (e.g., any fully-autonomous or semi-autonomous vehicle). As further shown in FIG. 1, the autonomous vehicle 102 may include a positioning system 104, a propulsion system 106, a braking system 108, and/or a controller 110.

The positioning system 104 may include one or more positioning components, such as a global positioning system (GPS), an inertial reference unit (IRU), an inertial measurement unit (IMU), a dead-reckoning navigation unit, a light detection and ranging (LIDAR) unit, and/or a radio detection and ranging (RADAR) unit. Accordingly, the positioning unit may be configured to determine autonomous vehicle position information that indicates a current estimated location of the autonomous vehicle 102, a current estimated heading of the autonomous vehicle 102, and/or a current estimated speed of the autonomous vehicle 102. Due to uncertainties and/or imprecision of the one or more position components of the positioning system 104, the estimated values of the autonomous vehicle position information may be subject to one or more errors, such as position error, yaw error, yaw rate error, lateral slip error, latency error, and/or one or more other types of error. Accordingly, the autonomous vehicle position information may also include autonomous vehicle position estimation error information that indicates the one or more errors (e.g., a respective magnitude or value of the one or more errors).

The propulsion system 106 may include one or more propulsion components of the autonomous vehicle 102. The one or more propulsion components may include, for example, a drive train (e.g., that includes a transmission), wheels, axles, or other components that are configured to facilitate propulsion of the autonomous vehicle 102 (e.g., movement of the autonomous vehicle 102 at a work site), such as to enable the autonomous vehicle 102 to travel at a particular speed. For example, the one or more propulsion components may facilitate propulsion of the machine when the one or more propulsion components are enabled. In contrast, the one or more propulsion components may not facilitate propulsion (or may prevent or mitigate propulsion) of the machine when the one or more propulsion components are disabled.

The braking system 108 may include one or more braking components of the autonomous vehicle 102. The one or more braking components may include, for example, one or more regenerative braking components, one or more dissipative braking components, one or more mechanical braking components, and/or one or more other braking components. The one or more braking components may be configured to apply a braking torque, such as to slow a speed of the autonomous vehicle 102 (e.g., from a current speed to a lower speed), to maintain a current speed of the autonomous vehicle 102, and/or to stop the autonomous vehicle 102.

The controller 110 may be an electronic control module (ECM) or other computing device. The controller 110 may be in communication (e.g., by a wired connection or a wireless connection) with the positioning system 104, the propulsion system 106, and/or the braking system 108. The controller 110 may also be in communication with other components and/or systems of the autonomous vehicle 102, and/or other systems external to the autonomous vehicle 102 (e.g., as further described herein). The controller 110 may be configured to control a speed of the autonomous vehicle 102 (e.g., by causing one or more autonomous vehicle speed control operations to be performed, as further described herein), which may include communicating with the positioning system 104, the propulsion system 106, and/or the braking system 108.

As indicated above, FIG. 1 is provided as an example. Other examples may differ from what is described in connection with FIG. 1.

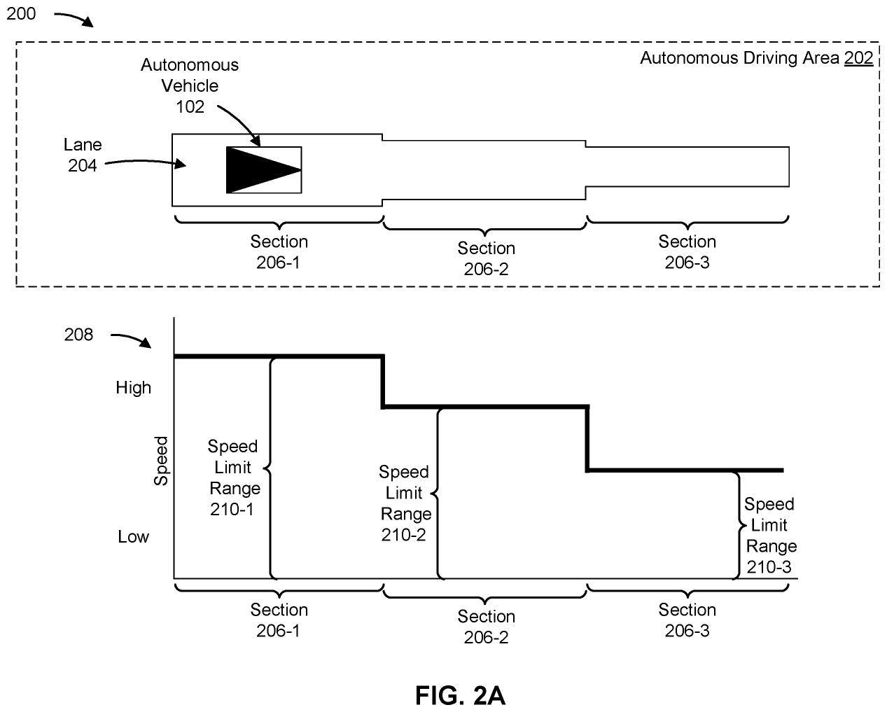

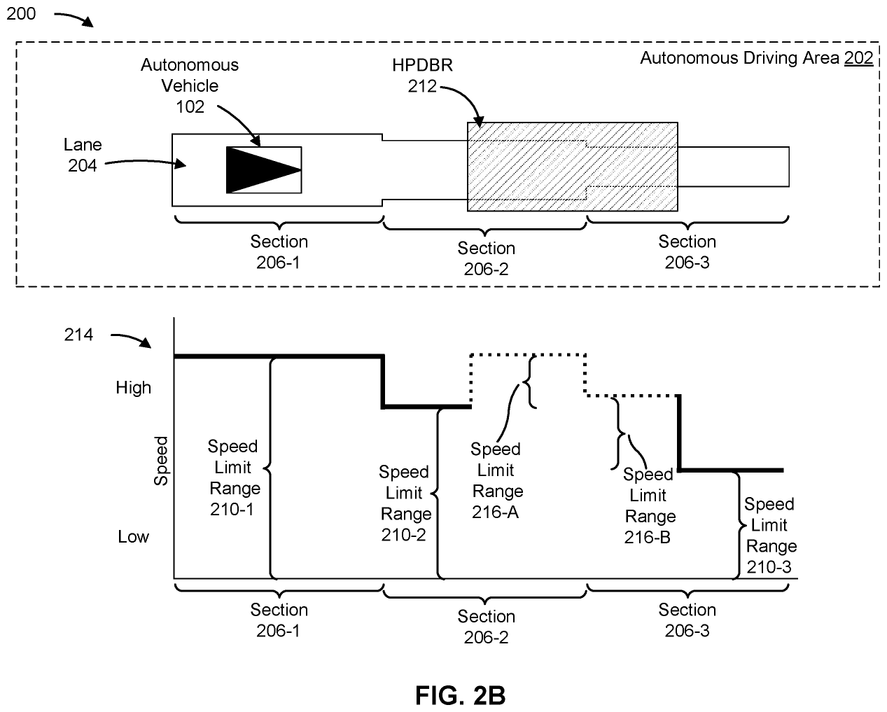

FIGS. 2A-2B are diagrams associated with an example physical region 200 (e.g., shown from a top-down view), which may include a work site, one or more streets, one or more highways, one or more offroad paths, and/or the like. As shown in FIGS. 2A-2B, the physical region 200 may include an autonomous driving area 202 (e.g., an area in which autonomous vehicles may be able to, and allowed to, autonomously drive), which may include a lane 204. The autonomous vehicle 102 (shown as a black triangle in a rectangle, where a point of the triangle indicates a heading of the autonomous vehicle 102) may be configured to travel along the lane 204 within the autonomous driving area 202.

As shown in FIGS. 2A-2B, the lane 204 may include one or more sections 206, shown as sections 206-1, 206-2, 206-3. Each section 206 may have a particular width (e.g., that is different than respective widths of one or more other sections 206). For example, as shown in FIGS. 2A-2B, the section 206-1 may have a width that is greater than a width of the section 206-2, which may be greater than a width of the section 206-3. According to a speed plan of the autonomous vehicle 102 for the autonomous driving area 202, the controller 110 may be configured to cause the autonomous vehicle 102 to travel along each section 206 at a speed that is within a particular speed limit range 210 (e.g., at a speed that is greater than or equal to a minimum speed of the particular speed limit range 210 and that is less than or equal to a maximum speed of the particular speed limit range 210).

For example, as shown by plot 208 in FIG. 2A, the controller 110 may be configured to cause the autonomous vehicle 102 to travel along the section 206-1 at a speed within a speed limit range 210-1, to travel along the section 206-2 at a speed within a speed limit range 210-2, and to travel along the section 206-3 at a speed within a speed limit range 210-3. As further shown by the plot 208, a maximum speed of the speed limit range 210-1 may be greater than a maximum speed of the speed limit range 210-2 (e.g., because the width of the section 206-1 is greater than the width of the section 206-2, which allows for a greater maximum speed), and a maximum speed of the speed limit range 210-2 may be greater than a maximum speed of the speed limit range 210-3 (e.g., because the width of the section 206-2 is greater than the width of the section 206-3).

As shown in FIG. 2B, the autonomous driving area 202 may include an HPDBR 212. The HPDBR 212 may extend across a portion of the lane 204, such as over at least a portion of at least one section of the one or more sections 206. For example, as shown in FIG. 2B, the HPDBR 212 extends over a portion of the section 206-2 and a portion of the section 206-3. The HPDBR 212 may be a region in which the autonomous vehicle 102 may travel at speeds that exceed maximum speeds indicated by the speed plan of the autonomous vehicle 102 for the autonomous driving area 202 (e.g., when a risk of driving off course or colliding with a vehicle or person is minimized). Accordingly, the controller 110 may be configured to cause the autonomous vehicle 102 to travel along a portion of a section 206 of the lane 204 that is included in the HPDBR 212 at a speed that is within a particular speed limit range 216 (e.g., that has a maximum speed that is greater than a maximum speed of a speed limit range 210 that is associated with the section 206).

For example, as shown by plot 214 in FIG. 2B, the controller 110 may be configured to cause the autonomous vehicle 102 to travel along a portion of the section 206-2 that is included in the HPDBR 212 at a speed within a speed limit range 216-A, and to travel along a portion of the section 206-2 that is included in the HPDBR 212 at a speed within a speed limit range 216-B. As further shown by the plot 214, a minimum speed of the speed limit range 216-A may be greater than a maximum speed of the speed limit range 210-2 (e.g., because the speed limit range 216-A is associated with the HPDBR 212), and a minimum speed of the speed limit range 216-B may be greater than a maximum speed of the speed limit range 210-3 (e.g., because the speed limit range 216-B is associated with the HPDBR 212).

As indicated above, FIGS. 2A-2B are provided as an example. Other examples may differ from what is described in connection with FIGS. 2A-2B.

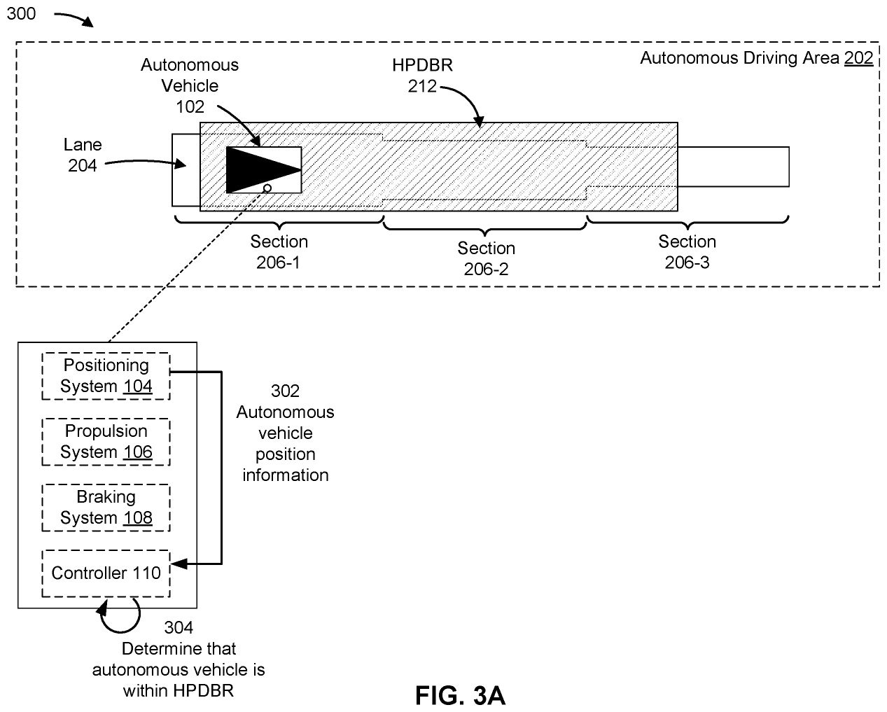

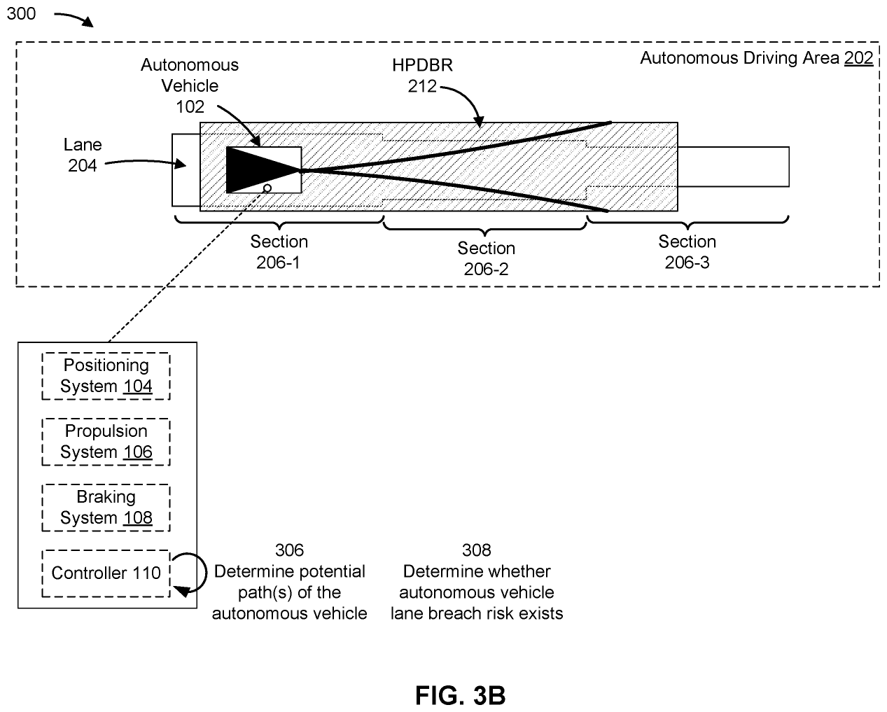

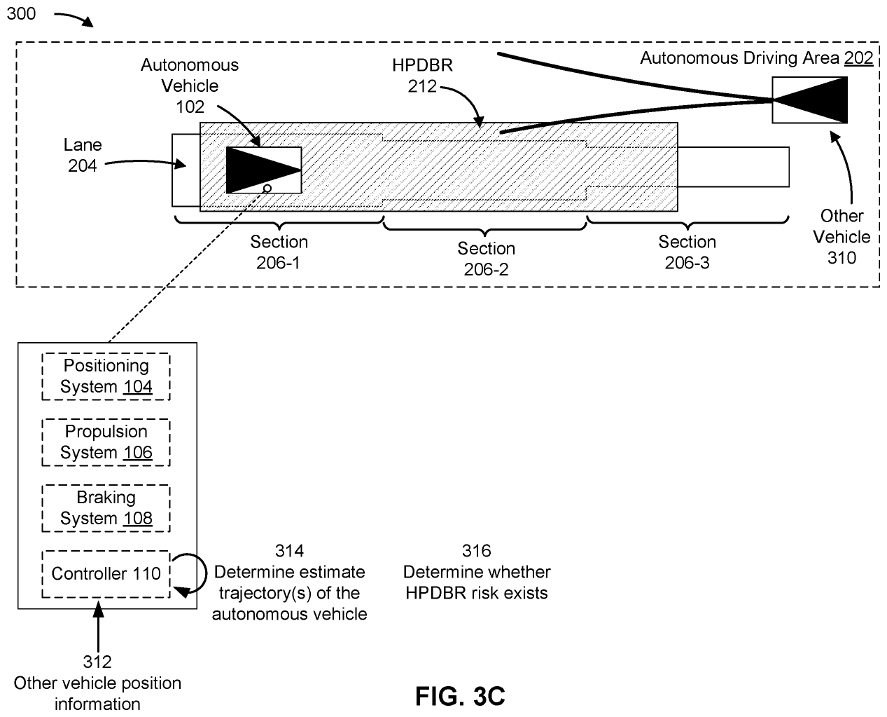

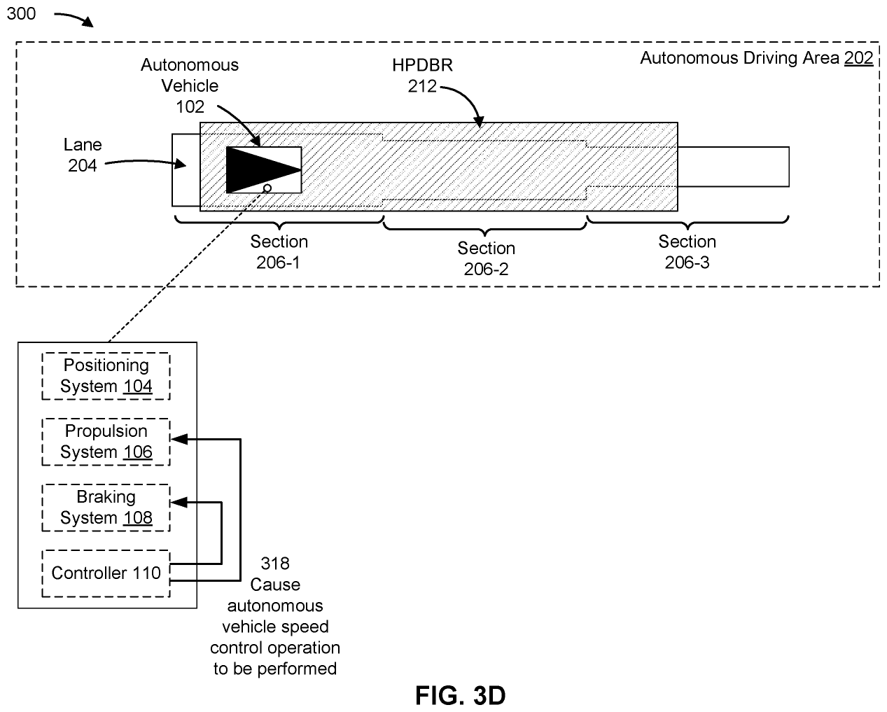

FIGS. 3A-3D are diagrams associated with an example implementation 300. As shown in FIGS. 3A-3D, the autonomous vehicle 102 may travel along the lane 204, and may travel within the HPDBR 212. Accordingly, the controller 110 may perform one or more of the operations described herein in relation to FIGS. 3A-3D.

As shown in FIG. 3A, and by reference number 302, the controller 110 may obtain autonomous vehicle position information. The autonomous vehicle position information may indicate a current estimated location of the autonomous vehicle 102 (e.g., in terms of geographical coordinates, or another measure of location), a current estimated heading of the autonomous vehicle 102 (e.g., in degrees relative to a reference direction, such as north), a current estimated speed of the autonomous vehicle 102 (e.g., in kilometers per hour, miles per hour, or another measure of speed), and/or other related information. The autonomous vehicle position information may also include autonomous vehicle position estimation error information that indicates one or more errors (e.g., respective magnitudes or values of the one or more errors) that are associated with the estimated values of the autonomous vehicle position information.

The controller 110 may obtain the autonomous vehicle position information from the positioning system 104. For example, the positioning system 104 may send the autonomous vehicle position information to the controller 110 as the positioning system 104 determines the autonomous vehicle position information (e.g., in real-time or near real-time). As another example, the positioning system 104 may send the autonomous vehicle position information to the controller 110 on a scheduled basis, on an on-demand basis, on a triggered basis, or on an ad-hoc basis.

As shown by reference number 304, the controller 110 may determine that the autonomous vehicle 102 is located within the HPDBR 212 (e.g., based on the autonomous vehicle position information). For example, the controller 110 may identify a map of the autonomous driving area 202 (e.g., that is stored in a data structure that is accessible to the controller 110) and may determine that the autonomous vehicle 102 is within a boundary of the HPDBR 212 (e.g., as indicated by the map).

Accordingly, based on determining that the autonomous vehicle 102 is located within the HPDBR 212, the controller 110 may determine whether an HPDBR-related risk exists, which may include determining whether an autonomous vehicle lane breach risk exists (e.g., as further described in relation to FIG. 3B) and/or determining whether an HPDBR intersection risk exists (e.g., as further described in relation to FIG. 3C).

As shown in FIG. 3B, and by reference number 306, the controller 110 may determine one or more potential paths of the autonomous vehicle 102 (e.g., based on determining that the autonomous vehicle 102 is located within the HPDBR 212). A potential path of the autonomous vehicle 102 may be a potential path of the autonomous vehicle 102 during a particular time window (e.g., that may have a duration of 1 second, 2 seconds, 3 seconds, 5 seconds, 10 seconds, or another amount of time), given, for example, current and potential operating characteristics of the autonomous vehicle 102 (e.g., of the positioning system 104, the propulsion system 106, the braking system 108, and/or the controller 110), one or more physical conditions of the HPDBR 212 (e.g., in terms of traction, elevation, slope, and/or other physical conditions), and/or other related conditions. As shown in FIG. 3B, two potential paths of the autonomous vehicle 102 are shown (e.g., from the point of view of the autonomous vehicle 102, a “leftward” potential path of the autonomous vehicle 102 and a “rightward” potential path of the autonomous vehicle 102). In some implementations, the one or more potential paths of the autonomous vehicle 102 may include one or more “most extreme” potential paths of the autonomous vehicle 102, such as a most extreme leftward potential path of the autonomous vehicle 102 (e.g., when the autonomous vehicle 102 is set with a most extreme leftward steering direction) and/or a most extreme rightward potential path of the autonomous vehicle 102 (e.g., when the autonomous vehicle 102 is set with a most extreme rightward steering direction). In this way, the controller 110 may determine a “potential path zone” of the autonomous vehicle 102, in which any potential path of the autonomous vehicle 102 is contained.

The controller 110 may determine the one or more potential paths of the autonomous vehicle 102 based on the speed limit range 216 of the HPDBR 212 and/or the autonomous vehicle position information. For example, the controller 110 may determine a potential path by using a maximum speed of the speed limit range 216 (e.g., for a portion of a section 206 of the lane 204) and the current estimated location of the autonomous vehicle 102, the current estimated heading of the autonomous vehicle 102, the current estimated speed of the autonomous vehicle 102, and/or the autonomous vehicle position estimation error information of the autonomous vehicle position information.

As shown by reference number 308, the controller 110 may determine whether an autonomous vehicle lane breach risk exists (e.g., based on determining the one or more potential paths of the autonomous vehicle 102). An autonomous vehicle lane breach risk exists, for example, when a potential path of the autonomous vehicle 102 breaches a side of the lane 204. For example, as shown in FIG. 3B, the most extreme leftward potential path of the autonomous vehicle 102 intersects a “left” side of the lane 204 and the most extreme rightward potential path of the autonomous vehicle 102 intersects a “right” side of the lane 204. Alternatively, an autonomous vehicle lane breach risk does not exist, for example, when each of the one or more potential paths of the autonomous vehicle 102 does not intersect a side of the lane 204. Put another way, an autonomous vehicle lane breach risk exists when the potential path zone of the autonomous vehicle 102 crosses a side of the lane 204, and does not exist when the potential path zone of the autonomous vehicle 102 does not cross any side of the lane 204.

To determine whether an autonomous vehicle lane breach risk exists, the controller 110 may determine an estimated drift of the autonomous vehicle 102 from the lane 204 (e.g., based on the one or more potential paths of the autonomous vehicle 102). The estimated drift may be, for example, for a potential path of the autonomous vehicle 102, a total shift of the autonomous vehicle 102 in a particular direction (e.g., a lateral direction, such as a rightward direction or a leftward direction) from a current location (e.g., a current estimated location) of the autonomous vehicle 102. The controller 110 may also identify (e.g., based on the map of the autonomous driving area 202) an estimated available margin of the autonomous vehicle 102 within the lane 204, which may be a total amount of space available in the lane 204, in the particular direction, from the current location of the autonomous vehicle 102. The controller 110 may thereby compare the estimated drift and the estimated available margin to determine whether an autonomous vehicle lane breach risk exists. For example, the controller 110 may determine that an autonomous vehicle lane breach risk exists by determining that the estimated drift is greater than the estimated available margin. As an alternative example, the controller 110 may determine that an autonomous vehicle lane breach risk does not exist by determining that the estimated drift is less than or equal to the estimated available margin.

As shown in FIG. 3C, in some implementations, another vehicle 310 may be located within the autonomous driving area 202. The other vehicle 310 may be another autonomous vehicle (e.g., that is similar to the autonomous vehicle 102) or a manned vehicle, such as a car or pickup truck. The other vehicle 310 may be located on the lane 204, or, alternatively, off the lane 204, and may have its own heading and speed. In some implementations, the other vehicle 310 may be stopped (e.g., may have a speed of zero (0) kilometers per hour, miles per hour, or another measure of speed). Accordingly, the autonomous vehicle 102 may determine whether an HPDBR intersection risk exists (e.g., whether a risk exists that the autonomous vehicle 102 may collide with the other vehicle 310 within the HPDBR 212).

As shown by reference number 312, the controller 110 may obtain other vehicle position information. The other vehicle position information may indicate a current estimated location of the other vehicle 310 (e.g., in terms of geographical coordinates, or another measure of location), a current estimated heading of the other vehicle 310 (e.g., in degrees relative to a reference point, such as north), a current estimated speed of the other vehicle 310 (e.g., in kilometers per hour, miles per hour, or another measure of speed), and/or other related information. The other vehicle position information may also include other vehicle position estimation error information that indicates one or more errors (e.g., respective magnitudes or values of the one or more errors) that are associated with the estimated values of the other vehicle position information.

The controller 110 may obtain the other vehicle position information from an external positioning system (not shown), such as a “central hub” positioning system of the autonomous driving area 202 that tracks respective positions of vehicles within the autonomous driving area 202 (e.g., by obtaining respective vehicle position information from the vehicles). For example, the external positioning system may send the other vehicle position information to the controller 110 as the external positioning system obtains and/or determines the other vehicle position information (e.g., in real-time or near real-time). As another example, the external positioning system may send the other vehicle position information to the controller 110 on a scheduled basis, on an on-demand basis, on a triggered basis, or on an ad-hoc basis. In some implementations, the controller 110 may directly obtain the other vehicle position information from the other vehicle 310 (e.g., via a wireless connection between the autonomous vehicle 102 and the other vehicle 310).

As shown by reference number 314, the controller 110 may determine one or more estimated trajectories of the other vehicle 310 (e.g., based on obtaining the other vehicle position information). An estimated trajectory of the other vehicle 310 may be an estimated trajectory of the other vehicle 310 during a particular time window (e.g., that may have a duration of 1 second, 2 seconds, 3 seconds, 5 seconds, 10 seconds, or another amount of time), given, for example, current and potential operating characteristics of the other vehicle 310, one or more physical conditions of the autonomous driving area 202 (e.g., in terms of traction, elevation, slope, and/or other physical conditions), and/or other related conditions. As shown in FIG. 3C, two estimated trajectories of the other vehicle 310 are shown (e.g., from the point of view of the other vehicle 310, a “leftward” estimated trajectory of the other vehicle 310 and a “rightward” estimated trajectory of the other vehicle 310). In some implementations, the one or more estimated trajectories of the other vehicle 310 may include one or more “most extreme” estimated trajectories of the other vehicle 310, such as a most extreme leftward estimated trajectory of the other vehicle 310 (e.g., when the other vehicle 310 is set with a most extreme leftward steering direction) and/or a most extreme rightward estimated trajectory of the other vehicle 310 (e.g., when the other vehicle 310 is set with a most extreme rightward steering direction). In this way, the controller 110 may determine an “estimated trajectory zone” of the other vehicle 310, in which any estimated trajectory of the other vehicle 310 is contained.

The controller 110 may determine the one or more estimated trajectories of the other vehicle 310 based on a maximum speed of the other vehicle 310 (e.g., a maximum possible travelling speed of the other vehicle 310 within the autonomous driving area 202) and/or the other vehicle position information. For example, the controller 110 may determine an estimated trajectory by using the maximum speed of the other vehicle 310, even when the other vehicle 310 is stopped or currently traveling at a low speed, and the current estimated location of the other vehicle 310, the current estimated heading of the other vehicle 310, the current estimated speed of other vehicle 310, and/or the other vehicle position estimation error information of the other vehicle position information.

As shown by reference number 316, the controller 110 may determine whether an HPDBR intersection risk exists (e.g., based on determining the one or more estimated trajectories of the other vehicle 310). An HPDBR intersection risk exists, for example, when at least one estimated trajectory, of the one or more estimated trajectories, crosses into the HPDBR 212 (e.g., regardless of whether the at least one estimated trajectory crosses into the lane 204). For example, as shown in FIG. 3C, the most extreme leftward estimated trajectory of the other vehicle 310 intersects a “top” side of the HPDBR 212. Alternatively, an HPDBR intersection risk does not exist, for example, when each estimated trajectory, of the one or more estimated trajectories, does not cross into the HPDBR 212. Put another way, an HPDBR intersection risk exists when the estimated trajectory zone of the other vehicle 310 crosses a side of the HPDBR 212, and does not exist when the estimated trajectory zone of the other vehicle 310 does not cross any side of the HPDBR 212.

Accordingly, the controller 110 may determine that an HPDBR intersection risk exists by determining that at least one estimated trajectory, of the one or more estimated trajectories of the other vehicle 310, crosses into the HPDBR 212. Alternatively, the controller 110 may determine that an HPDBR intersection risk does not exist by determining that each estimated trajectory, of the one or more estimated trajectories the other vehicle 310, does not cross into the HPDBR 212.

As shown in FIG. 3D, and by reference number 318, the controller 110 may cause an autonomous vehicle speed control operation to be performed (e.g., for the autonomous vehicle 102), such as based on whether an HPDBR-related risk exists. For example, the controller 110 may cause an autonomous vehicle speed control operation to be performed based on whether an autonomous vehicle lane breach risk exists and/or whether an HPDBR intersection risk exists.

In a first particular example, the controller 110 may cause, based on determining that an HPDBR-related risk does not exist (e.g., based on determining that an autonomous vehicle lane breach risk does not exist and/or determining that an autonomous vehicle lane breach risk does not exist), a speed of the autonomous vehicle 102 to be within the speed limit range 216 of the HPDBR 212 (e.g., for a portion of a section 206 of the lane 204 that is associated with the HPDBR 212 in which the autonomous vehicle 102 is currently located). This may cause the speed of the autonomous vehicle 102 to be greater than a maximum speed of the speed limit range 210 of the section 206. The controller 110 may send one or more commands (e.g., to the propulsion system 106 and/or the braking system 108, such as to enable and/or disable respective components of the propulsion system 106 and/or the braking system 108) to cause the speed of the autonomous vehicle 102 to be within the speed limit range 216 of the HPDBR 212.

In a second particular example, the controller 110 may cause, based on determining that an HPDBR-related risk exists (e.g., based on determining that an autonomous vehicle lane breach risk exists and/or determining that an autonomous vehicle lane breach exists), a speed of the autonomous vehicle 102 to be less than a current estimated speed of the autonomous vehicle 102 (e.g., as indicated by the autonomous vehicle position information) and/or to be less than a minimum speed of the speed limit range 216 of the HPDBR 212 (e.g., for a portion of a section 206 of the lane 204 that is associated with the HPDBR 212 in which the autonomous vehicle 102 is currently located). This may cause the speed of the autonomous vehicle 102 to be within the speed limit range 210 of the section 206. The controller 110 may send one or more commands (e.g., to the propulsion system 106 and/or the braking system 108, such as to enable and/or disable respective components of the propulsion system 106 and/or the braking system 108) to cause the speed of the autonomous vehicle 102 to be less than the current estimated speed of the autonomous vehicle 102 and/or to be less than the minimum speed of the speed limit range 216 of the HPDBR 212.

As indicated above, FIGS. 3A-3D are provided as an example. Other examples may differ from what is described in connection with FIGS. 3A-3D.

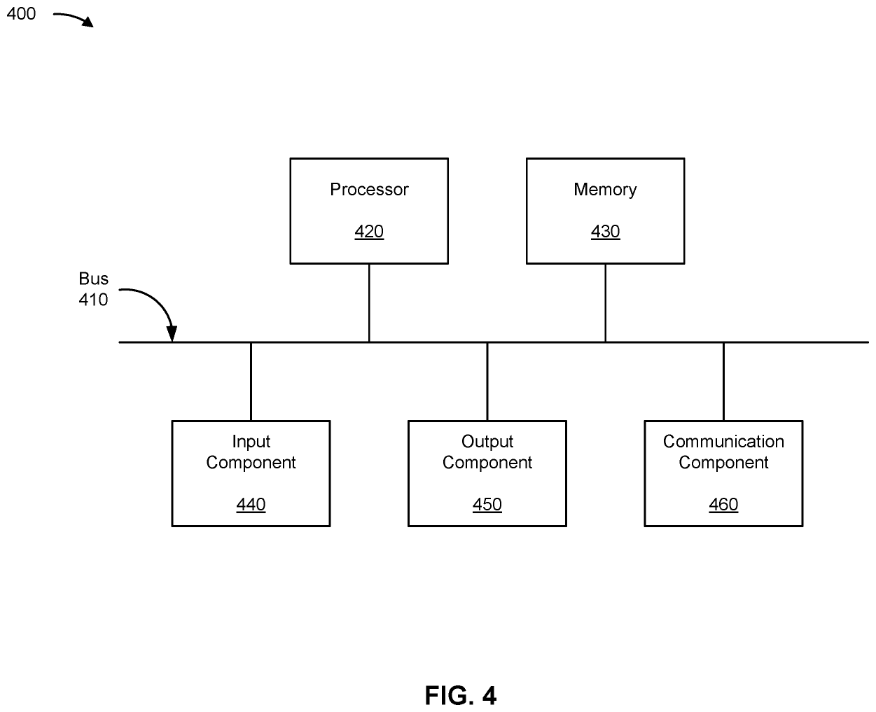

FIG. 4 is a diagram of example components of a device 400 associated with speed control for an autonomous vehicle in an HPDBR. The device 400 may correspond to the positioning system 104, the propulsion system 106, the braking system 108, and/or the controller 110. In some implementations, the positioning system 104, the propulsion system 106, the braking system 108, and/or the controller 110 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

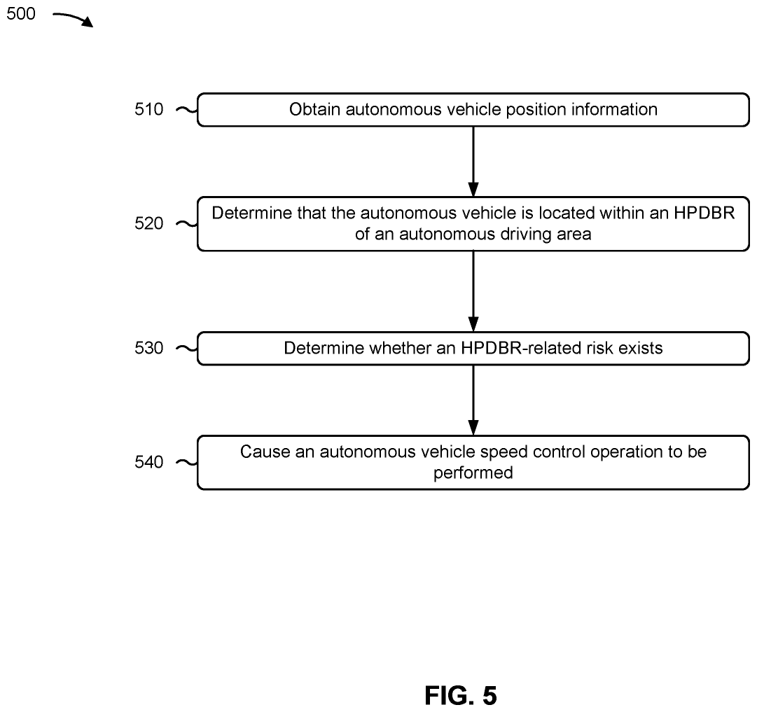

FIG. 5 is a flowchart of an example process 500 associated with speed control for an autonomous vehicle in an HPDBR. One or more process blocks of FIG. 5 may be performed by a controller (e.g., the controller 110). Additionally, or alternatively, one or more process blocks of FIG. 5 may be performed by another device or a group of devices separate from or including the controller, such as another device or component that is internal or external to the autonomous vehicle 102.

As shown in FIG. 5, process 500 may include obtaining autonomous vehicle position information (block 510). For example, the controller may obtain autonomous vehicle position information, as described above.

As further shown in FIG. 5, process 500 may include determining that the autonomous vehicle is located within an HPDBR of an autonomous driving area (block 520). For example, the controller may determine, based on the autonomous vehicle position information, that the autonomous vehicle is located within an HPDBR of an autonomous driving area, as described above.

As further shown in FIG. 5, process 500 may include determining whether an HPDBR-related risk exists (block 530). For example, the controller may determine, based on determining that the autonomous vehicle is located within the HPDBR, whether an HPDBR-related risk exists, as described above. Determining whether an HPDBR-related risk exists may comprise at least one of determining whether an autonomous vehicle lane breach risk exists, or determining whether an HPDBR intersection risk exists.

Determining whether an autonomous vehicle lane breach risk exists may comprise determining, based on a speed limit range of the HPDBR and the autonomous vehicle position information, an estimated drift of the autonomous vehicle from a lane associated with the HPDBR, identifying an estimated available margin of the autonomous vehicle within the lane, and comparing the estimated drift and the estimated available margin to determine whether an autonomous vehicle lane breach risk exists. Determining whether an HPDBR intersection risk exists may comprise determining, based on other vehicle position information, one or more estimated trajectories of another vehicle, and determining, based on the one or more estimated trajectories of the other vehicle, whether at least one estimated trajectory, of the one or more estimated trajectories, crosses into the HPDBR

As further shown in FIG. 5, process 500 may include causing an autonomous vehicle speed control operation to be performed (block 540). For example, the controller may cause, based on determining whether an HPDBR-related risk exists, an autonomous vehicle speed control operation to be performed, as described above. Causing the autonomous vehicle speed control operation to be performed may comprise one of causing, based on determining that an HPDBR-related risk does not exist, a speed of the autonomous vehicle to be within a speed limit range of the HPDBR, or causing, based on determining that an HPDBR-related risk exists, the speed of the autonomous vehicle to be less than a minimum speed of the speed limit range of the HPDBR.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

### INDUSTRIAL APPLICABILITY

The above-described techniques allow a controller 110 of an autonomous vehicle 102 to control a speed of the autonomous vehicle 102 within an HPDBR 212. When the autonomous vehicle 102 is located in the HPDBR 212, the controller 110 obtains autonomous vehicle position information and/or other vehicle position information to determine whether an HPDBR-related risk exists, such as whether an autonomous vehicle lane breach risk exists and/or whether an HPDBR intersection risk exists.

When the controller 110 determines that an HPDBR-related risk does not exist (e.g., that an autonomous vehicle lane breach risk does not exist and/or that an HPDBR intersection risk does not exist), the controller 110 causes an autonomous vehicle speed control operation to be performed to cause a speed of the autonomous vehicle 102 to be within a speed limit range 216 of the HPDBR 212. This causes the autonomous vehicle 102 to travel at an increased speed within the HPDBR 212. Alternatively, when the controller 110 determines that an HPDBR-related risk exists (e.g., that an autonomous vehicle lane breach risk exists and/or that an HPDBR intersection risk exists), the controller 110 causes an autonomous vehicle speed control operation to be performed to cause a speed of the autonomous vehicle 102 to be less than a current estimated speed of the autonomous vehicle 102 and/or to be less than a minimum speed of the speed limit range 216 of the HPDBR 212. This causes the autonomous vehicle 102 to travel at a decreased speed within the HPDBR 212.

In this way, by causing the autonomous vehicle 102 to travel at an increased speed within the HPDBR 212 when an HPDBR-related risk does not exist, the controller 110 enables the autonomous vehicle 102 to provide an improved performance. For example, by travelling at an increased speed between destinations within an autonomous driving area 202, the autonomous vehicle 102 is able to perform more tasks (e.g., loading, transporting, and/or offloading tasks, such as when the autonomous vehicle 102 is a mining truck) than would otherwise be able to be performed when travelling at a decreased speed. Additionally, by causing the autonomous vehicle 102 to travel at a decreased speed within the HPDBR 212 when an HPDBR-related risk exists, the controller 110 enables a safe working environment within the autonomous driving area 202. For example, by travelling at a decreased speed between destinations within an autonomous driving area 202 when there is a risk (even a slight risk) of the autonomous vehicle driving off course or colliding with another vehicle 310 (or people on foot that exited the other vehicle 310 when it stopped), the autonomous vehicle 102 prevents (or at least decreases a likelihood of) endangerment of the autonomous vehicle 102, the other vehicle 310, and any people present in the autonomous driving area 202.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

What is claimed is:

1. An autonomous vehicle comprising:
a positioning system; and
a controller configured to:
obtain autonomous vehicle position information from the positioning system;
determine, based on the autonomous vehicle position information, that the autonomous vehicle is located within a high performance driving behavior region (HPDBR) of an autonomous driving area;
determine, based on a speed limit range of the HPDBR and the autonomous vehicle position information, one or more potential paths of the autonomous vehicle;
determine, based on the one or more potential paths of the autonomous vehicle, whether an autonomous vehicle lane breach risk exists; and
cause, based on determining whether an autonomous vehicle lane breach risk exists, an autonomous vehicle speed control operation to be performed.

2. The autonomous vehicle of claim 1, wherein the controller, to cause the autonomous vehicle speed control operation to be performed, is configured to:
send, based on determining that an autonomous vehicle lane breach risk does not exist, one or more first commands to cause a speed of the autonomous vehicle to be within the speed limit range of the HPDBR, or
send, based on determining that an autonomous vehicle lane breach risk exists, one or more second commands to cause the speed of the autonomous vehicle to be less than a current estimated speed of the autonomous vehicle that is indicated by the autonomous vehicle position information.

3. The autonomous vehicle of claim 1, wherein the autonomous vehicle position information indicates autonomous vehicle position estimation error information and at least one of:
a current estimated location of the autonomous vehicle,
a current estimated heading of the autonomous vehicle, or
a current estimated speed of the autonomous vehicle.

4. The autonomous vehicle of claim 1, wherein the controller, to determine whether an autonomous vehicle lane breach risk exists, is configured to:
determine, based on the one or more potential paths of the autonomous vehicle, an estimated drift of the autonomous vehicle from a lane associated with the HPDBR;
identify an estimated available margin of the autonomous vehicle within the lane; and
compare the estimated drift and the estimated available margin to determine whether an autonomous vehicle lane breach risk exists.

5. The autonomous vehicle of claim 4, wherein the controller, to compare the estimated drift and the estimated available margin to determine whether an autonomous vehicle lane breach risk exists, is configured to:
determine that the estimated drift is greater than the estimated available margin; and
determine, based on determining that the estimated drift is greater than the estimated available margin, that an autonomous vehicle lane breach risk exists.

6. The autonomous vehicle of claim 4, wherein the controller, to compare the estimated drift and the estimated available margin to determine whether an autonomous vehicle lane breach risk exists, is configured to:
determine that the estimated drift is less than or equal to the estimated available margin; and
determine, based on determining that the estimated drift is less than or equal to the estimated available margin, that an autonomous vehicle lane breach risk does not exist.

7. The autonomous vehicle of claim 1, wherein the controller is further configured to:
obtain other vehicle position information;
determine, based on the other vehicle position information, one or more estimated trajectories of another vehicle;
determine, based on the one or more estimated trajectories of the other vehicle, whether an HPDBR intersection risk exists; and
cause, based on determining whether an HPDBR intersection risk exists, another autonomous vehicle speed control operation to be performed.

8. The autonomous vehicle of claim 7, wherein the controller, to cause the other autonomous vehicle speed control operation to be performed, is configured to:
send, based on determining that an HPDBR intersection risk does not exist, one or more first commands to cause a speed of the autonomous vehicle to be within the speed limit range of the HPDBR, and
send, based on determining that an HPDBR intersection risk exists, one or more second commands to cause the speed of the autonomous vehicle to be less than a minimum speed of the speed limit range of the HPDBR.

9. A controller of an autonomous vehicle, comprising:
one or more memories; and
one or more processors configured to:
obtain autonomous vehicle position information from a positioning system of the autonomous vehicle;
determine, based on the autonomous vehicle position information, that the autonomous vehicle is located within a high performance driving behavior region (HPDBR) of an autonomous driving area;
obtain, based on determining that the autonomous vehicle is located within the HPDBR, other vehicle position information;
determine, based on the other vehicle position information, one or more estimated trajectories of another vehicle;
determine, based on the one or more estimated trajectories of the other vehicle, whether an HPDBR intersection risk exists; and
cause, based on determining whether an HPDBR intersection risk exists, an autonomous vehicle speed control operation to be performed.

10. The controller of claim 9, wherein the one or more processors, to cause the autonomous vehicle speed control operation to be performed, are configured to:
send, based on determining that an HPDBR intersection risk does not exist, one or more first commands to cause a speed of the autonomous vehicle to be within a speed limit range of the HPDBR, and
send, based on determining that an HPDBR intersection risk exists, a one or more second commands to cause the speed of the autonomous vehicle to be less than a minimum speed of the speed limit range of the HPDBR.

11. The controller of claim 9, wherein the other vehicle position information indicates other vehicle position estimation error information and at least one of:
a current estimated location of the other vehicle,
a current estimated heading of the other vehicle, or
a current estimated speed of the other vehicle.

12. The controller of claim 9, wherein the one or more processors, to determine whether an HPDBR intersection risk exists, are configured to:
determine that each estimated trajectory, of the one or more estimated trajectories, does not cross into the HPDBR; and
determine, based on determining that each estimated trajectory does not cross into the HPDBR, that an HPDBR intersection risk does not exist.

13. The controller of claim 9, wherein the one or more processors, to determine whether an HPDBR intersection risk exists, are configured to:
determine, based on the one or more estimated trajectories of the other vehicle, that at least one estimated trajectory, of the one or more estimated trajectories, crosses into the HPDBR; and
determine, based on determining that the at least one estimated trajectory crosses into the HPDBR, that an HPDBR intersection risk exists.

14. The controller of claim 9, wherein the one or more processors are further configured to:
determine, based on a speed limit range of the HPDBR and the autonomous vehicle position information, one or more potential paths of the autonomous vehicle;
determine, based on the one or more potential paths of the autonomous vehicle, whether an autonomous vehicle lane breach risk exists; and
cause, based on determining whether an autonomous vehicle lane breach risk exists, another autonomous vehicle speed control operation to be performed.

15. The controller of claim 9, wherein the one or more processors, to cause the autonomous vehicle speed control operation to be performed, are configured to:
send, based on determining that an HPDBR intersection risk does not exist, one or more first commands to cause a speed of the autonomous vehicle to be within a speed limit range of the HPDBR, and
send, based on determining that an HPDBR intersection risk exists, one or more second commands to cause the speed of the autonomous vehicle to be less than a minimum speed of the speed limit range of the HPDBR.

16. A method, comprising:
obtaining, by a controller of an autonomous vehicle, autonomous vehicle position information;
determining, by the controller and based on the autonomous vehicle position information, that the autonomous vehicle is located within a high performance driving behavior region (HPDBR) of an autonomous driving area;
determining, by the controller and based on determining that the autonomous vehicle is located within the HPDBR, whether an HPDBR-related risk exists; and
causing, by the controller and based on determining whether an HPDBR-related risk exists, an autonomous vehicle speed control operation to be performed.

17. The method of claim 16, wherein determining whether an HPDBR-related risk exists comprises at least one of:
determining whether an autonomous vehicle lane breach risk exists; or
determining whether an HPDBR intersection risk exists.

18. The method of claim 17, wherein determining whether an autonomous vehicle lane breach risk exists comprises:
determining, based on a speed limit range of the HPDBR and the autonomous vehicle position information, an estimated drift of the autonomous vehicle from a lane associated with the HPDBR;
identifying an estimated available margin of the autonomous vehicle within the lane; and
comparing the estimated drift and the estimated available margin to determine whether an autonomous vehicle lane breach risk exists.

19. The method of claim 17, wherein determining whether an HPDBR intersection risk exists comprises:
determining, based on other vehicle position information, one or more estimated trajectories of another vehicle; and
determining, based on the one or more estimated trajectories of the other vehicle, whether at least one estimated trajectory, of the one or more estimated trajectories, crosses into the HPDBR.

20. The method of claim 16, wherein causing the autonomous vehicle speed control operation to be performed comprises one of:
causing, based on determining that an HPDBR-related risk does not exist, a speed of the autonomous vehicle to be within a speed limit range of the HPDBR, or
causing, based on determining that an HPDBR-related risk exists, the speed of the autonomous vehicle to be less than a minimum speed of the speed limit range of the HPDBR.
